(19) United States
(12) Patent Application Publication
(10) Pub. No.: US 2026/0001817 A1
(43) Pub. Date: Jan. 1, 2026

(54) FIBER PREFORM CONTAINING TEXTILE MARKERS

(71) Applicant: SAFRAN CERAMICS, LE HAILLAN (FR)

(72) Inventors: Aline PLANCKEEL, MOISSY-CRAMAYEL (FR); Marie LEFEBVRE, MOISSY-CRAMAYEL (FR); Ramuntxo ETCHART-SALAS, MOISSY-CRAMAYEL (FR); Maxime François Roger CARLIN, MOISSY-CRAMAYEL (FR)

(21) Appl. No.: 19/107,872

(22) PCT Filed: Aug. 30, 2023
(86) PCT No.: PCT/FR2023/051311

§ 371 Date: Feb. 28, 2025

(30) Foreign Application Priority Data
Aug. 31, 2022 (FR) FR2208703

(51) Int. Cl. C04B 35/80; C04B 35/628; C04B 35/657; D03D 15/242; D03D 25/00

(52) U.S. Cl. CPC C04B 35/80; C04B 35/62884; C04B 35/62886; C04B 35/657; D03D 15/242; D03D 25/005; C04B 2235/428; C04B 2235/5224; C04B 2235/5244; C04B 2235/5256; C04B 2235/612; C04B 2235/614; C04B 2235/616; D10B 2101/02; D10B 2101/16; D10B 2505/02

(57) ABSTRACT

A fiber preform for manufacturing a component made of composite material, the fiber preform exhibiting three-dimensional weaving and having a usable zone extending between two edge zones, the fiber preform further including at least two tracer filaments woven in the one same, weft or warp, direction and belonging to two different layers of weft filaments or warp filaments, each one being present in a distinct edge zone, the tracer filaments having a second composition different from the first composition, each tracer filament creating at least one textile marker on the surface of the fiber preform, a textile marker being created by the appearance of the tracer filament on the surface of the preform.

### TECHNICAL FIELD

The invention relates to the field of composite materials and more specifically to fiber preforms for the manufacture of these materials or to the methods for manufacturing such preforms or such materials.

### PRIOR ART

Composite materials are of increasing technological interest and have found a wide variety of uses in recent years.

In particular, organic matrix composites (OMCs) and ceramic matrix composites (CMCs) are replacing metal components in some parts of turbomachines. Their use contributes to optimizing aircraft performance, in particular by improving the efficiency of the turbomachine and reducing the overall mass of the turbomachine, significantly reducing emissions harmful to the environment (CO, CO₂, NOₓ, etc.).

The preparation of such materials is usually done by forming a matrix within a fiber preform. The mechanical properties of the final component depend not only on the composition of the preform and the matrix, but also on the weaving chosen for the preform, and the orientation of the fibers in the preform.

This is why the fiber preform cannot be randomly disposed in the component manufacturing methods. In particular, it is desirable that the preform can be placed precisely in a shaper or in a densification tool. Thus, it is possible to identify certain particular zones or directions of the preform, which ensures that the mechanical properties of the final component are those expected.

Typically, a particular direction of the preform is marked with a tracer filament woven in that direction and which has a different appearance from the filaments on the rest of the preform. This allows for visual identification of a particular direction of the preform, which facilitates correct positioning of the preform in the tool.

In order for the appearance of the tracer filaments to be different from the rest of the preform, the tracer filaments are of a different nature from the other filaments in the preform. For example, for a silicon carbide fiber preform, the tracer filaments are generally chosen to be alumina filaments.

Although this solution is satisfactory overall, it has been observed that the tracer filaments, due to their different nature, do not exhibit the same behavior as the rest of the preform during the formation of the matrix.

For example, it has been observed that the matrix does not form as well in the area around the tracer filament as on the rest of the surface of the preform. This poor formation of the matrix near the tracer filament results in an absence of matrix or a matrix present in low thickness around the filament, which can lead to non-conformity of the component made of composite material in particular since a zone including less matrix can lead to a zone not having the desired properties.

On the one hand, it is necessary to have a preform whose orientation can be known so that it can be placed precisely in a shaper or densification tool. On the other hand, there remains a need for a preform free of the disadvantages described above and associated with the use of tracer filaments in the usable zone.

### DISCLOSURE OF THE INVENTION

The invention aims precisely at meeting this need.

For this purpose, according to a first of its aspects, the invention proposes a fiber preform for manufacturing a component made of composite material, the fiber preform exhibiting three-dimensional weaving comprising a plurality of layers of weft filaments and a plurality of layers of warp filaments extending in a direction perpendicular to the direction of the weft filaments, in which each weft filament binds warp filaments of several layers, the weft filaments and the warp filaments having a first composition, the fiber preform having a usable zone extending between two edge zones,

the fiber preform being characterized in that it further comprises at least two tracer filaments woven in the one same, weft or warp, direction and belonging to two different layers of weft filaments or warp filaments, each one being present in a distinct edge zone, the tracer filaments having a second composition, different from the first composition, each tracer filament creating at least one textile marker on the surface of the fiber preform, a textile marker being created by the appearance of the tracer filament on the surface of the preform.

The preform of the invention has several advantages.

The tracer filament is present only in the edge zones of the preform. In this way, the usable zone of the preform does not comprise tracer filaments, and thus, the consolidation and/or densification of the preform by the matrix are not affected by the presence of this tracer filament.

However, it remains possible to identify a particular direction of the preform, by aligning the two textile markers formed respectively by the first tracer filament and the second tracer filament.

It is recalled that consolidation is understood as a step of partial densification of the fiber preform, which allows it to be given sufficient rigidity so that it can hold its shape, without the need for an external support element.

The amount of matrix present in the preform after the consolidation step is, however, less than the amount of matrix desired in the final component.

Preform densification is understood as the step in which the matrix is introduced into the fiber preform in an amount sufficient to form the final component.

In one embodiment, the consolidation may be accomplished by chemical vapor infiltration (or CVI).

In one embodiment, the densification of the preform may be achieved by melt-infiltration (or MI) or chemical vapor infiltration (or CVI).

In this application, the usable zone of a preform will be called the textile zone which will actually form the fiber preform of the final component.

Indeed, conventionally in a method for preparing a component made of composite material, a larger surface of preform than that strictly necessary to produce the desired component is woven, possibly consolidated, then densified by the matrix. The component is finally machined to the desired final dimensions in this densified preform of larger dimensions. It is during this final machining step that the edge zones of the preform are removed.

Alternatively, the preform can be consolidated, then machined to its final shape, before being densified by the die.

In any event, the invention allows to have a preform in which the usable zone is free of tracer filaments, and therefore, the final component does not comprise zones that are little or poorly densified by the matrix.

However, since the tracer filaments are present at the time when the fiber preform is placed in the shaper or in the densification tool, they allow to identify a particular direction of the fiber preform which can pass into the usable zone of the preform by aligning the two textile markers.

In a particular embodiment where the textile markers of the first and second tracer filaments are produced at the same time of weaving, the alignment of the two textile markers allows to easily identify the direction perpendicular to the weaving direction of the tracer filaments.

Thus, if the tracer filaments are present in the warp, and the markers are formed by passing the two tracer filaments over the same layer of weft filaments, the alignment of the two textile markers allows to identify the weft direction.

Conversely, if the tracer filaments are present in the weft, and the markers are formed by passing the two tracer filaments above the same layer of warp filaments, the alignment of the two textile markers allows to identify the warp direction.

In one embodiment, the textile marker formed by the tracer filament may be a textile knee. The textile knee is a weaving pattern in which no float is made with the tracer filament, that is to say the latter passes over a single surface filament.

To form a textile knee, the tracer filament is present inside the preform before the textile marker, it rises from the inside of the preform to the surface to form the textile marker by passing over a surface filament, then plunges back into the depth of the preform just after the textile marker.

This embodiment allows for greater precision in the particular direction identified by the alignment of two textile markers.

Indeed, the particular direction of the preform which is identified by the alignment of two textile markers is more precisely defined when the textile markers are small.

In one embodiment, two textile markers are spaced at least 2 cm apart.

This embodiment allows for better identification of textile markers.

Indeed, the textile markers even more visible when the tracer filaments are less present on the surface, because the contrast with the other filaments of the preform is then more marked.

In one embodiment, the filaments of the first composition are made of silicon carbide.

In one embodiment, the filaments of the second composition, that is to say the tracer filaments, are alumina filaments.

This embodiment allows to have a ceramic tracer filament, resistant to the treatments that the preform sees during the component preparation method.

Furthermore, alumina filaments allow good visual identification of the latter compared to the filaments used for fiber preforms of composite materials, in particular silicon carbide filaments.

In one embodiment, a single tracer filament can form several textile markers in the weaving direction of the tracer filament.

In this embodiment, the weaving direction of the tracer filament is then easily identifiable by the alignment of several textile markers formed by the same tracer filament.

According to another of its aspects, the invention relates to a method for manufacturing a preform as described above and having a usable zone extending between two edge zones, which comprises a three-dimensional weaving of a plurality of layers of weft filaments and a plurality of layers of warp filaments extending in a direction perpendicular to the direction of the weft filaments, the weft filaments and the warp filaments having a first composition, the method being characterized in that it further comprises at least one step of inserting two tracer filaments in the same weft or warp direction, the tracer filaments each being woven in a distinct edge zone, the tracer filaments having a second composition different from the first composition, the method further comprising at least one operation of raising each of the tracer filaments to form at least one textile marker per tracer filament on the surface of the preform.

In one embodiment, the operation of raising the tracer filaments is a step of punctual textile inversion between a filament of first surface composition and a tracer filament in order to form a textile knee.

According to another of its aspects, the invention relates to a method for manufacturing a component made of composite material comprising at least one step of arranging a preform as described above in a tool during which one or more particular directions of the preform identified by the textile markers of the preform are aligned in one or more particular directions of the tool; a step of densifying the preform by a matrix; and a machining step to remove the edge zones of the fiber preform.

The inventors found that such a method simply allowed to use the same tools as those previously developed and in which it is planned to arrange the preform in a particular direction, while avoiding the impregnation inhomogeneities caused by the presence of the tracer filaments.

Indeed, identifying the particular direction of the preform does not require, in the preforms described above, the physical presence of a tracer filament in the usable zone. The tracer filaments are present in the edge zones, and it is the alignment of the textile markers that they form that allows to identify the particular direction of the preform.

The presence of the tracer filaments in the edge zones of the preform of the invention certainly locally disrupts the densification, but only in the edge zones that are no longer present in the final component. This provides an implementation method that is as simple as the methods of the prior art, but which allows to obtain components in which the homogeneity of the densification of the preform is ensured.

In one embodiment, the tool of a method for manufacturing a fiber preform is a shaper, and the method further comprises a consolidation step, before the densification step.

In such an embodiment, a particular direction of the fiber preform may be disposed in a particular direction of said shaper.

It should be noted that the consolidation step remains optional. Indeed, in certain embodiments the preform does not require consolidation and can be directly placed in a densification tool.

In one embodiment, the densification tool comprises a particular direction that is aligned with a particular direction of the fiber preform.

In one embodiment, the consolidation step may be performed by chemical vapor infiltration (or CVI).

In one embodiment, the step of densifying the fiber preform is carried out by liquid infiltration (or MI for “melt-infiltration”), for example by liquid infiltration of molten silicon.

For example, in such an embodiment, part of the fiber preform is contacted with a bath of molten silicon, which then infiltrates the fiber preform by capillarity.

In one embodiment, the machining step takes place after the step of densifying the fiber preform.

In another embodiment, and when a consolidation step is present, the machining step may occur after the consolidation step and before the densification step.

### BRIEF DESCRIPTION OF THE DRAWINGS

FIG. 1 schematically shows a preform of the prior art.

FIG. 2 schematically shows a preform according to the invention.

FIG. 3 schematically shows a woven preform in one embodiment of the invention.

FIG. 4 schematically shows a woven preform in one embodiment of the invention.

FIG. 5 schematically shows a woven preform in one embodiment of the invention.

FIG. 6 schematically shows the arrangement of a preform in a shaper, in one embodiment of the invention.

### DESCRIPTION OF THE EMBODIMENTS

The invention is now described by means of figures which should not be interpreted in a limiting manner and which are present only for illustrative purposes.

Throughout the application, in accordance with the usual convention of weaving, the weaving directions are referred to as weft and warp. It is stated that the invention and its technical effects are also easily obtained if the weft and warp directions are reversed, that is to say, if throughout the application all occurrences of “weft” are replaced by “warp” and vice versa.

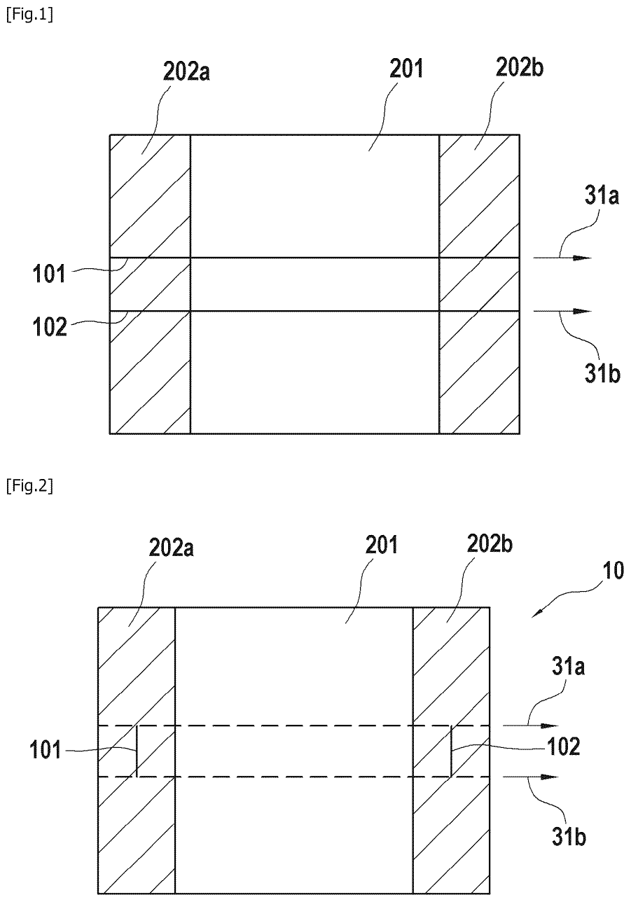

FIG. 1 describes a prior art fiber preform.

It comprises a usable zone 201 present between two edge zones 202a and 202b.

Two particular directions of the prior art fiber preform 31a and 31b can be identified by the presence of two tracer filaments 101 and 102.

However, and as described above, to be visible, these tracer filaments are of nature that is different from the rest of the filaments of the fiber preform. Since they are present in the usable zone, the tracer filaments can locally cause poor impregnation of the fiber preform, which harms the mechanical characteristics of the final component.

FIG. 2 shows a fiber preform 10 according to a first embodiment.

The preform 10 comprises two tracer filaments 101 and 102, which are not present in the usable zone, and which appear locally on the surface of the preform 10.

The particular directions 31a and 31b of the preform nevertheless remain easily identifiable, by aligning the textile markers formed by the tracer filaments 101, 102.

In FIG. 2, the textile markers are sufficiently long to identify the two particular directions 31a, 31b by aligning each end of one textile marker with the corresponding end of the other textile marker, but this should not be considered as limiting the invention.

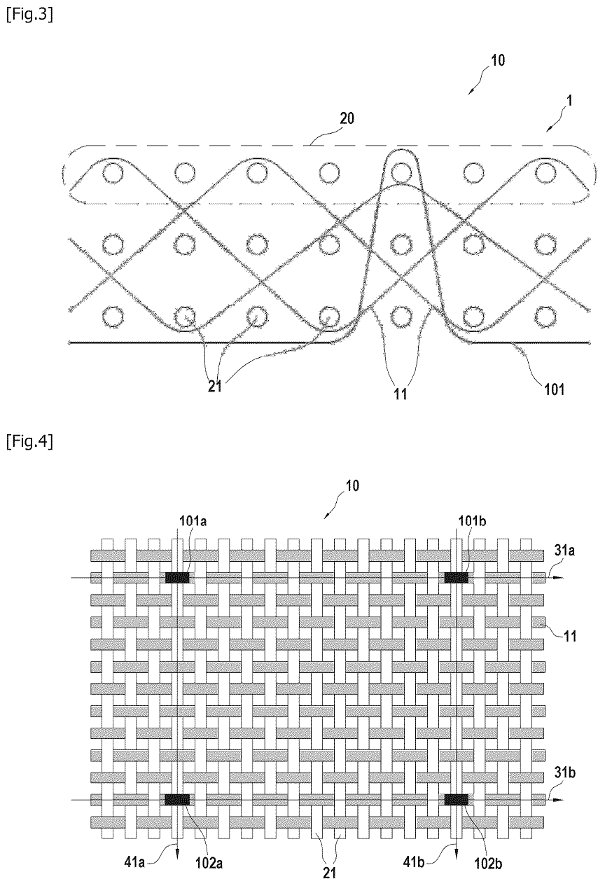

FIG. 3 shows a fiber preform 10 comprising a plurality of weft filaments 11 and a plurality of warp filaments 21 of a first composition.

In the representation of FIG. 3, the warp filaments 21 extend perpendicular to the representation and this is why they are represented by their circular sections.

The warp filaments 21 forming the surface layer 20 are also shown circled in dotted lines in FIG. 3.

The preforms of the invention comprise a three-dimensional weaving. Thus and as shown in FIG. 3, the same weft filament 11 binds warp filaments 21 belonging to several distinct layers of warp filaments. In this way, the preform has relative strength in the direction perpendicular to its surface. In particular, the fiber preforms having a three-dimensional weaving are more resistant to delamination than preforms which do not comprise a three-dimensional weaving.

“Three-dimensional weaving” or “3D weaving” means here a weaving method whereby at least some of the warp filaments bind weft filaments over several weft layers, such as an “interlock weave”. “Interlock weave” means here a 3D weaving in which each warp layer binds several weft layers with all the filaments of the same warp layer having the same movement in the plane of the weaving.

In the preform shown, the weft filaments 11 bind three layers of warp filaments. However, it is not excluded that the weft filaments 11 bind more than three layers of warp filaments 21. Also, the preform may or may not comprise weft filaments not shown in FIG. 3, which bind fewer layers of warp filaments, or even which pass between the warp filaments 21 without binding them. The latter are then non-binding weft filaments and increase the mechanical strength of the fiber preform.

FIG. 3 further shows a tracer filament 101, of a composition different from the weft filaments 11 and warp filaments 21. The tracer filament 101 is present in depth of the preform, except at a single point of the weaving where it is present on the surface.

This point of the weaving where the tracer filament passes on the surface of the preform forms a textile marker.

Indeed, the visual contrast created by the presence of the tracer filament 101 on the surface of the preform allows easy identification of the textile marker.

Furthermore, it should be noted that FIG. 3 shows a preform comprising only 3 layers of warp filaments 21 but this representation is schematic and only represents the few upper layers of warp filaments of a preform. An actual preform may comprise a much larger number of layers of warp filaments, which is determined according to the desired thickness for the preform 10. In particular, the tracer filament 101 shown in FIG. 3 should not be understood as being on the surface of the preform, but rather between several warp layers thereof.

In one embodiment, the tracer filament is present in depth of the preform as a non-binding filament, that is to say that it is not present on the surface, and that it does not weave the warp filaments, except for the production of the textile markers. In another embodiment, the tracer filament can be a binding filament, which is interchanged with a filament of the first composition present on the surface at the time of the formation of a textile marker.

In one embodiment, the tracer filament 101 can also take the place of a binding filament of the preform, while ensuring however that said filament of the preform does not pass on the surface, and the tracer filament will be taken out of the depth of the preform for the formation of the textile markers.

In one embodiment, the tracer filament 101 remains present inside the preform throughout the preform, which makes weaving easier, that is to say it is not extracted from the preform 10 after the formation of the textile markers 101a, 101b, 102a or 102b. However, since it is present in the edge zones 202a, 202b and not the usable zone 201 of the preform, it is not necessary to take any special precautions so that the latter does not disturb the densification of the preform.

In one embodiment, two textile markers 101a, 101b, 102a, 102b are spaced at least 2 cm apart.

FIG. 4 schematically shows the preform 10 seen from above.

As just described in connection with FIG. 3, the entire preform is composed of weft filaments 11 and warp filaments 21 of a first composition, with the exception of tracer filaments 101 of a second composition.

The tracer filaments are of a second composition, having a different visual appearance from the filaments of the first composition 11, 21. Thus, when the tracer filament is present on the surface of the preform, this creates textile markers 101a, 101b, 102a, 102b, which can be identified with the naked eye.

In one embodiment, the tracer filament 101, 102 is present in depth of the preform, except when the textile markers are produced.

The preform 10 comprises two separate tracer filaments 101, 102, belonging to two different layers of weft or warp filaments. The first tracer filament allows the formation of the markers 101a and 101b, while the second tracer filament forms the markers 102a and 102b.

As shown in FIG. 4, the textile markers 101a, 101b, 102a, 102b allow to identify particular directions 31a, 31b, 41a, 41b of the preform 10.

In one embodiment, the same tracer filament 101 can be used to create several textile markers 101a, 101b or 102a, 102b, provided that it is not present on the surface of the preform between two textile markers. In such an embodiment, the two tracer filaments 101, 102 allow on the one hand to identify a particular direction 41a, 41b by aligning a textile marker belonging to each of the tracer filaments 101, 102, and on the other hand to identify the weaving direction of the tracer filaments 101, 102 by aligning two textile markers of the same tracer filament 31a, 31b.

The alignment of two textile markers, formed by two different tracer filaments, 101a and 102a or 101b and 102b, allows to identify particular directions of the preform 41a, 41b, without requiring a filament to be entirely visible in this direction.

The presence of two tracer filaments 101 in the weft direction allows to identify a particular direction different from the weaving direction of the tracer filament 101.

In one embodiment, the particular direction identified by the textile markers 101a, 101b, 102a, 102b of two separate tracer filaments 101 may be the weft or warp direction.

However, the invention is not limited to this embodiment, and the choice of the location of the textile markers 101a, 101b, 102a, 102b allows to identify other particular directions.

FIGS. 3 and 4 explain how the tracer filament 101 allows to form a textile marker 101a, 101b, 102a, 102b on the surface of a preform and how these textile markers 101a, 101b, 102a, 102b allow to identify one or more particular directions.

In another embodiment, however, the tracer filament 101 may be introduced into the preform during weaving. For example, a tracer filament 101 may be introduced into the preform 10 at a point of debinding of the preform.

It should be noted that FIGS. 3 and 4 are schematic of a woven preform, and that the latter can have a three-dimensional weaving of any nature.

Different three-dimensional weaving may be used, for example, the woven preform may be an interlock, multi-satin or multi-plain woven preform, for example, as described in WO 2006/136755.

In one embodiment, the preform may be a preform of an aeronautical component, for example a turbomachine blade preform, a turbomachine ring preform or a distributor preform.

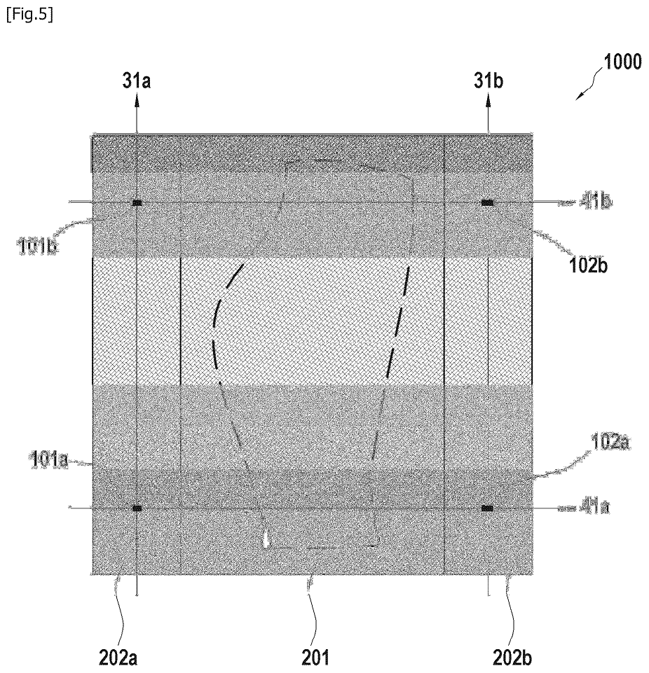

FIG. 5 shows a fiber preform 1000 of the invention, which comprises two edge zones 202a 202b and one usable zone 201.

To aid understanding, a turbomachine blade that can be formed in the usable zone 201 is shown in dotted lines.

As shown, the preform 1000 comprises textile markers 101a, 101b, 102a, 102b for identifying particular directions 31a, 31b, 41a and 41b.

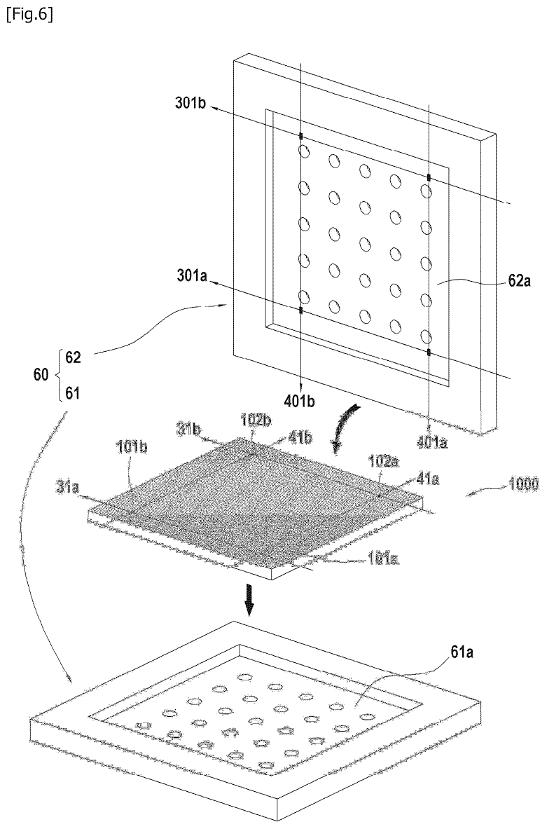

FIG. 6 schematically shows a method for arranging a preform 1000 in a tool, here a shaper 60.

The shaper 60 comprises a first 61 and a second shaper part 62.

In one embodiment, the arrangement of the preform 1000 in the cavity of the shaper 60 comprises a step of aligning the particular directions of the fiber preform 31a, 31b, 41a, 41b identified by the textile markers 101a, 101b, 102a, 102b with particular directions of the shaper 301a, 301b, 401a and 401b.

This particular arrangement ensures that all the steps of preparation of the final component made of composite material are carried out with preforms oriented in a particular direction, chosen to allow the mechanical properties expected in the final component to be obtained.

The description has been made for a method which comprises a consolidation step and the advantages have been discussed for the arrangement of a preform in a shaper, but it should be noted that this is not essential, and that the technical advantages of the preforms which have been described would allow them to be arranged, by identifying their particular directions 31a, 31b, 41a, 41b, in densification tools rather than a shaper 60.

1. A fiber preform for manufacturing a component made of composite material, the fiber preform exhibiting three-dimensional weaving comprising a plurality of layers of weft filaments and a plurality of layers of warp filaments extending in a direction perpendicular to the direction of the weft filaments, in which each weft filament binds warp filaments of several layers, the weft filaments and the warp filaments having a first composition, the fiber preform having a usable zone extending between two edge zones, and
the fiber preform further comprising at least two tracer filaments woven in the one same, weft or warp, direction and belonging to two different layers of weft filaments or warp filaments, each one being present in a distinct edge zone, the tracer filaments having a second composition, different from the first composition, each tracer filament creating at least one textile marker on the surface of the fiber preform, a textile marker being created by the appearance of the tracer filament on the surface of the preform.

2. The preform according to claim 1, wherein two textile markers are spaced at least 2 cm apart.

3. The preform according to claim 1, wherein the filaments of the first composition are made of silicon carbide.

4. The preform according to claim 1, wherein the tracer filaments of the second composition are alumina filaments.

5. The preform according to claim 1, wherein the textile markers formed by the tracer filament are textile knees.

6. A method for manufacturing a preform according to claim 1, and having a usable zone extending between two edge zones, which comprises a three-dimensional weaving of a plurality of layers of weft filaments and a plurality of layers of warp filaments extending in a direction perpendicular to the direction of the weft filaments, the weft filaments and the warp filaments having a first composition,
the method further comprising at least one step of inserting two tracer filaments in the same weft or warp direction, the tracer filaments each being woven in a distinct edge zone, the tracer filaments having a second composition different from the first composition, the method further comprising at least one operation of raising each of the tracer filaments to form at least one textile marker per tracer filament on the surface of the preform.

7. The method for manufacturing a component made of composite material comprising at least one step of arranging a preform according to claim 1 in a tool during which one or more particular directions of the preform identified by the textile markers of the preform are aligned in one or more particular directions of the tool; a step of densifying the preform; and a machining step to remove the edge zones of the fiber preform.

8. The method for manufacturing a component made of composite material according to claim 7, wherein the tool is a shaper, and the method further comprises a consolidation step, before the densification step.

9. The method for manufacturing a component made of composite material according to claim 7, wherein the step of densifying the preform is carried out by liquid infiltration of molten silicon or by chemical vapor infiltration.
